(19) United States
(12) Patent Application Publication
(10) Pub. No.: US 2025/0111370 A1
(43) Pub. Date: Apr. 3, 2025

(54) REAL-TIME DIGITAL VERIFICATION IN FRAUD DEFENSE

(71) Applicant: Aven Holdings, Inc., Burlingame, CA (US)

(72) Inventor: Usman Ghani, Burlingame, CA (US)

(21) Appl. No.: 18/902,215

(22) Filed: Sep. 30, 2024

Related U.S. Application Data
(60) Provisional application No. 63/586,279, filed on Sep. 28, 2023.

(51) Int. Cl. G06Q 20/40

(52) U.S. Cl. CPC G06Q 20/4015; G06Q 20/4016

(57) ABSTRACT

A method and system for real-time, secure digital verification is disclosed. In some embodiments, the method includes instructing a user to provide personal data and receiving behavior data about the user, the personal data including location information of the user. The method also includes verifying the user based on at least one of the personal data and the behavior data. The method further includes determining whether to grant the user access to a certain asset in response to the user verification.

### CROSS-REFERENCE TO RELATED APPLICATION

This application claims the benefit of U.S. Provisional Patent Application No. 63/586,279, titled “Digital Verification of Physical Address in Fraud Defense,” and filed on Sep. 28, 2023, the entire content of which is incorporated by reference herein.

### TECHNICAL FIELD

This disclosure relates to digital verification using at least real-time location information in time-sensitive applications in an enhanced fraud detection and mitigation manner.

### BACKGROUND

Verification is commonly used to establish certain truths in various situations such as bank account applications, credit card transactions, employment eligibility verification, official documents (e.g., driver license, visa) application, etc. However, a verification process often handles complex data, interactions, and relationships, which is vulnerable to human error and document forgery, and is difficult to be integrated with digital systems (e.g., when verifying a physical item), etc. In particular, there is a lack of real-time verification. In addition, the validity of these verification processes is susceptible to fraud.

Current verification and related fraud defense are explained herein in an example of a home equity line of credit (HELOC) application. HELOC applicants often have difficulty in getting access to funds. One problem is that a time-to-fund (TTF), i.e., the time from booking to access to cash (i.e., executing a cash out), is too long. This problem relates to two main delays. One is the rescission period, a period set forth by the Truth in Lending Act (TILA) under U.S. federal law. Another delay in fund access relates to the card (e.g., physical HELOC card) printing and mailing process. The card printing and mailing process is usually slow due to the required production (e.g., physical card printing) and movement of the physical card through physical mailing systems (e.g., delivered to the address of the applicant, etc.). The reasons for this delay are valuable in fraud defense. For example, a fraudster would have to intercept an actual mail delivery/mailbox and have physical access to an applicant's home/mailbox/mail delivery in order to steal a physical card.

Verifying a physical HELOC card before fund release would reduce the fraud risk, but the verification itself may cause additional delays to an applicant's access to the fund since the applicant needs to wait until the receipt of the physical HELOC card before accessing the fund. Therefore, a reasonable and secure verification mechanism is desired.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

To address the aforementioned shortcomings and other related problems, a method and system for real-time, secure digital verification in fraud defense are provided in the present disclosure. According to one embodiment, the method disclosed herein includes instructing a user to provide personal data. The personal data includes the location information of the user. In some embodiments, behavior data about the user is also collected. The method then verifies the user based on at least one of the personal data and the behavior data. The method further includes determining whether to grant the user access to a certain asset in response to the outcome of the verification.

In some embodiments, the user is an applicant who is waiting for the arrival of a physical card to access the requested asset, and determining whether to grant the user access to the asset includes determining whether to make partial aseet available to the user before the arrival of the physical card. In some embodiments, the location information used for verification is determined through communications between a portable device associated with the user and a base station using techniques including signal processing through trilateration or triangulation. In some embodiments, the location information is collected in real time. In some embodiments, the behavior data includes one or more fraud scores or confidence scores that reflect the behavior patterns of the user.

In some embodiments, the method disclosed herein for fraud defense specifically includes receiving a video or image including the location information of the user; verifying the location information of the user based on video or image information; determining partial access for the user based on verifying the user as at least a low-risk user; and authorizing the user partial access to the asset. In some embodiments, the method further includes analyzing the video to extract the location information of the user, where the analyzing includes reverse image search. In some embodiments, the personal data includes one or more contact lists submitted by the user, and the method further includes at least one of examining whether the one or more contact lists include an empty list or determining whether the one or more contact lists include a bad contact point. In some embodiments, the method further includes comparing a number of bad contact points in one or more contact lists with a threshold value and calculating a ratio for determining the extent of partial access to the expected funds or assets.

In some embodiments, the method further includes applying one or more artificial intelligence (AI) and machine learning models to perform AI-driven behavioral analysis to identify deviations and potential threats associated with the user. In some embodiments, the method further includes providing a feedback mechanism when verifying the user, where the feedback mechanism is applied using one or more AI models.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### DETAILED DESCRIPTION

The disclosed embodiments have advantages and features that will be more readily apparent from the detailed description, the appended claims, and the accompanying figures (or drawings). A brief introduction of the figures is below.

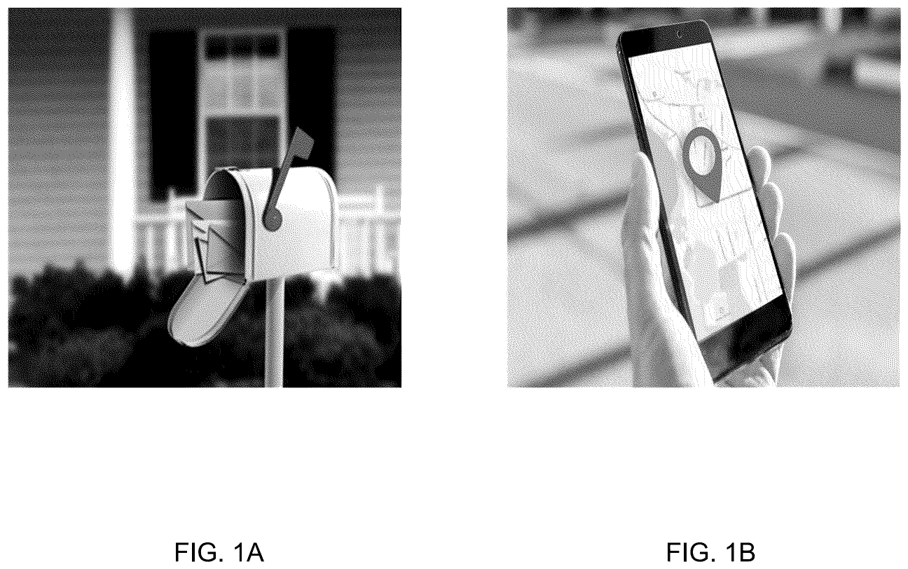

FIGS. 1A and 1B illustrate an exemplary digital verification scenario, according to some embodiments.

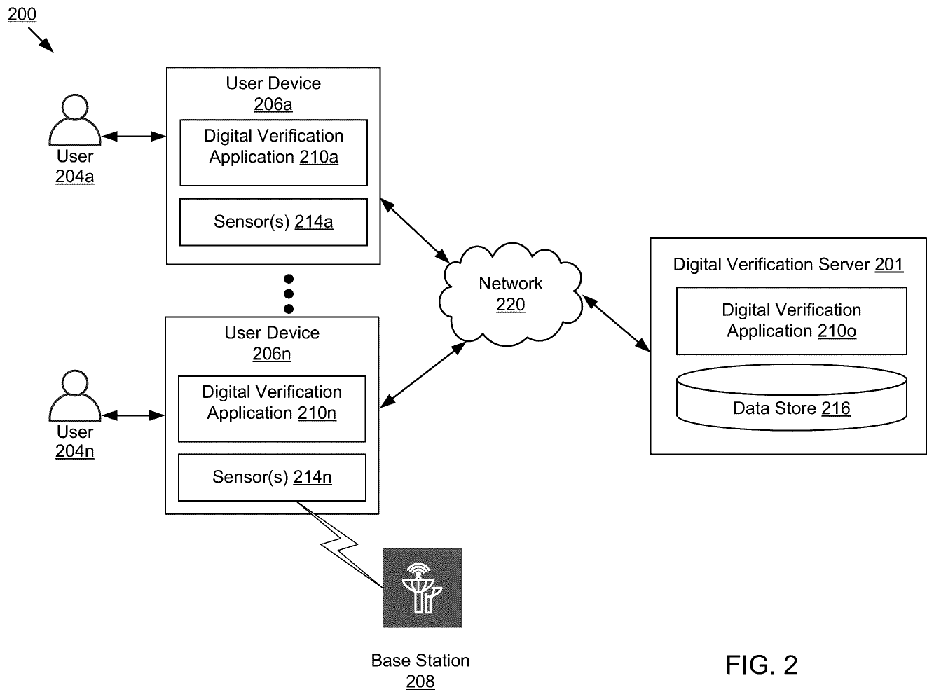

FIG. 2 illustrates an example system for digital verification, according to some embodiments.

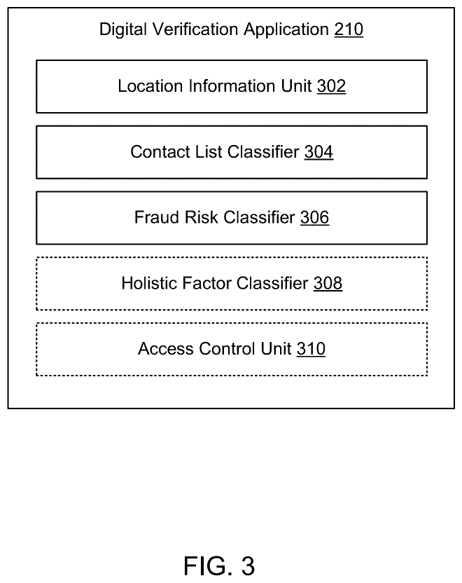

FIG. 3 illustrates example components of a digital verification application, according to some embodiments.

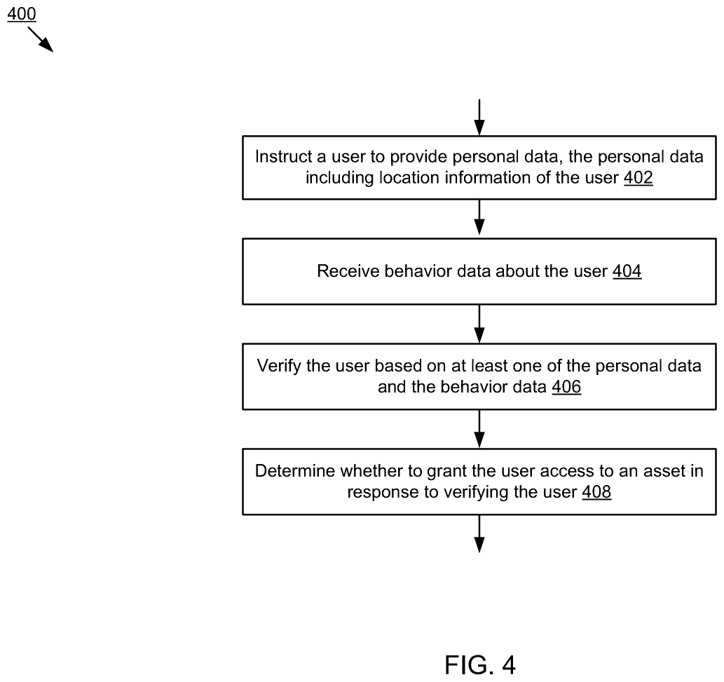

FIG. 4 illustrates an exemplary flow chart for digital verification and early access to fund, according to some embodiments.

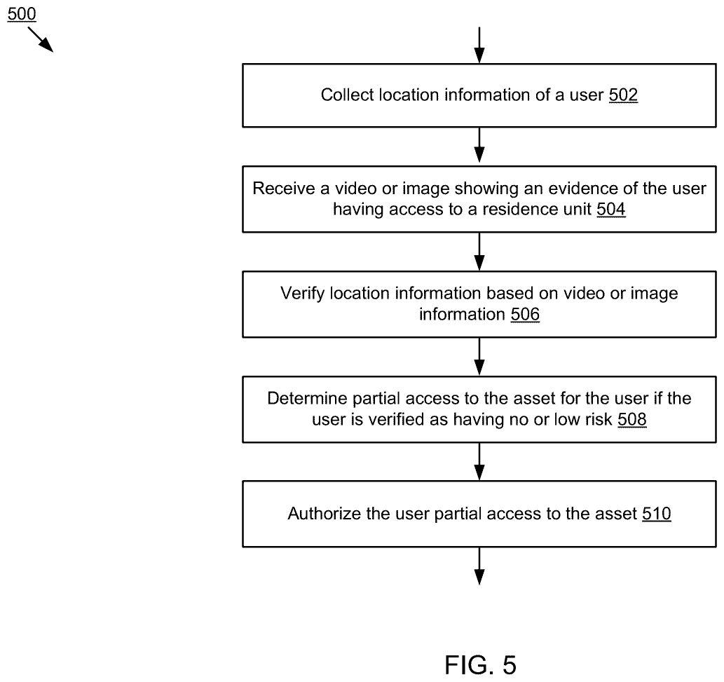

FIG. 5 illustrates an exemplary flow chart for digital verification using location information, according to some embodiments.

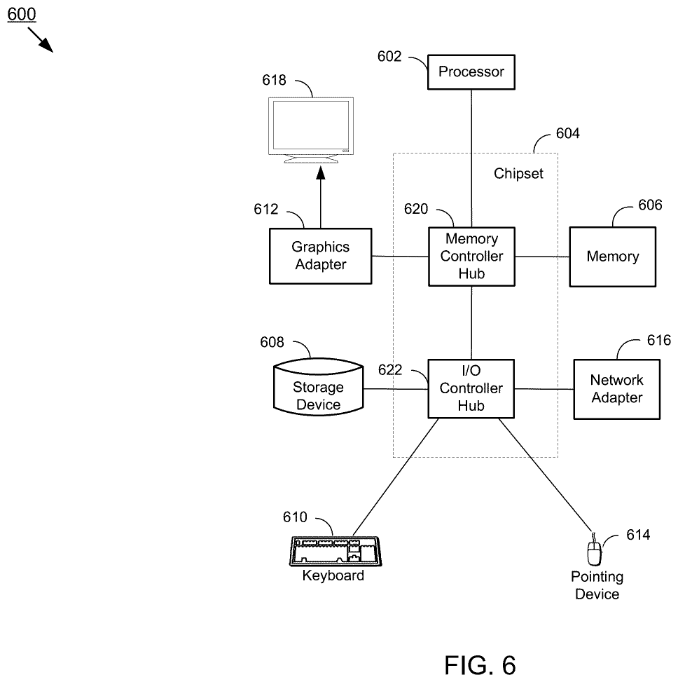

FIG. 6 shows an example computing device for implementing systems and methods described in reference to FIGS. 2-5.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Conventional verification methods often lack real-time capabilities (i.e., no immediate results), which can lead to delays (e.g., TTF delays discussed above) in accessing services, completing transactions, or managing product manufacturing, etc. This becomes increasingly problematic in today's fast-paced digital environment where seamless and efficient user experiences are expected. In addition, it is difficult to detect fraud in verification processes, putting the vulnerability of the entire service/transaction/manufacturing system at risk.

The present disclosure provides one or more time-sensitive and secure digital verification approaches to solving the technical problems (e.g., untimely verification, potential fraud, etc.) as discussed above. For example, the present verification approach may be conducted in an early stage of HELOC fund in a low fraud-risk manner. The present digital verification approaches aim to reduce the delay in services, transactions, manufactures, and any other applicable fields without compromising the quality of services, transactions, etc. That is, the present verification can be applied to reduce the TTF by enabling a user to fully digitally activate his/her HELOC card and thus have an opportunity to access to the fund before receiving the physical card by mail. In the meantime, this verification is conducted with an increased security level (e.g., better level of fraud defense) compared to the conventional mail delivery-based verification. While some of the digital verification approaches are described herein in the context of the HELOC card example, it should be noted that the present disclosure is not limited in this exemplary case and can be used to satisfy different verification needs in different areas.

FIGS. 1A and 1B illustrate an exemplary digital verification scenario. Compared to the existing verification process, instead of waiting for a physical mail containing the HELOC card to arrive at an applicant's residence unit (as shown in FIG. 1A), the disclosed system may present one or more graphical user interfaces (GUIs) on a user device associated with the applicant (as shown in FIG. 1B) and instruct the applicant to provide certain digital evidences to a trusted entity (e.g., the authority associated with the HELOC card, or a backend authorization server entrusted by the authority). The purpose of this process is to verify that the applicant has the physical access to the residence unit associated with the HELOC card. Since the digital evidences can be delivered in a short period of time, the verification using the digital evidences can be quicker than the physical verification in the current practice (e.g., mail-based verification), thereby saving the time necessary for the verification by the HELOC card companies before releasing the fund to the applicant. Accordingly, the applicant may be able to access the line of credit earlier than the current practice. The specific details of various digital verification processes are further described below.

As data breaches become more and more common and fraud techniques grow increasingly sophisticated, fraud defense becomes more and more challenging. In an exemplary credit card application, one of the key type of fraud to defend against is someone who has stolen a homeowner's identity, and knows the location of the home, but does not have access to the physical mailbox of the homeowner. To ensure a low fraud risk, one or more digital evidences may be submitted for verification purposes, according to the embodiments of the present disclosure.

In some embodiments, the system disclosed herein may instruct a user to provide digital evidence(s) or pull the evidence(s) out from one or more user devices associated with the user (under the permission of the user). For example, the disclosed system may receive the user's location from a manual report, or initiate the acquisition of the user's location based on geo-location signals exchanged between a portable device associated with the user and a base station (e.g., a wireless station, a satellite base station). In addition to the personal information submitted by the user for verification, the present system may further use behavior data and/or third-party data to verify the user. For example, a low-risk or high-risk user classification (e.g., based on third-party data) that accounts for a user's behavior may be factored into verification. In some embodiments, the digital evidences used in the present verification process include, but are not limited to, location information, contact information, bank account information, risk level information, etc.

One digital evidence submitted for verification to reduce fraud risk may be the location information of a user (e.g., a credit card applicant). The location information can support that the applicant has physical access to the residence unit associated with the applicant's card (e.g., the address for mail delivery of the card). To achieve such an objective, the present system may instruct the applicant to report his/her physical location in real-time when the applicant is within the residence unit or in the foreground (or back ground) of the residence unit if the building structure of the residence unit prevents the location information from being collected when the applicant is inside the residence unit. The present system may also identify the user's location by enabling a user device associated with the applicant to report the location information of the user in real-time (e.g., through a global positioning system (GPS)).

In some embodiments, to provide additional evidence, the present system may instruct the applicant to provide one or more images or videos that further support that the applicant has physical access to the residence unit. In one example, a video showing that the applicant is walking into the residence unit from the foreground or back ground may be uploaded for verification purposes. Additionally or alternatively, the present system may allow one or more images to be uploaded for verification purposes. For example, one or more images taken from outside the residence unit showing that the applicant stands inside the residence unit can be used as the evidence. For another example, one or more images taken from inside the residence unit may be also used as the evidence. In yet another example, images of both outside and inside the residence unit can be used as the evidence.

In some embodiments, when these images and/or videos are taken, the location information of the camera or webcam of a mobile device may be also activated, so that the metadata information of these images and/or videos may tell where these images have been taken (e.g., geotagged images/videos). The present system may extract such metadata information from the images/videos and perform verification based on the metadata information. In some embodiments, when the videos or images are taken, an address sign (if any) for the residence unit may also be included and used for verification purposes.

A second digital evidence suitable for verification may be a contact list, according to some embodiments. For example, the system disclosed herein may receive one or more contact lists from a user (e.g., a credit card applicant), and, in response, verify that there is no empty contact list and/or there are no other known bad contact points (e.g., suspicious phone numbers, spam contributors, etc.) in the contact list. In some embodiments, the present system may have a blacklist that includes bad contact points collected from various sources. The present system may compare the contact list submitted by the applicant with the blacklist to determine whether there are bad contact points in the contact list collected from the applicant. If no bad contact point is found from the contacts in the contact list submitted by the applicant, the present system may consider the applicant as digitally verified (i.e., the applicant has no or low risk).

A third likely digital evidence suitable for verification may be the bank account accessibility associated with a user/applicant. For example, if the applicant has access to a bank account (which is not associated with a high-risk bank) with the matching name, the applicant may be considered digitally verified.

In some embodiments, one or more other risk factors may be also used for digital verification purposes. Such factors may include, but are not limited to, fraud score (e.g., SentiLink score), phone number confidence level, and credit score (e.g., FICO score). For example, the present system may verify a user based at least in part on the logic that low-risk users generally have one or more of low SentiLink scores, high confidence phone number matches, or high credit scores. These scores or confidence levels may be reported by the applicant or obtained by the present system from other sources for digital verification purposes. In some embodiments, user behaviors may be analyzed for user verification purposes, as will be described in detail later.

In some embodiments, certain actions can be taken to reduce possible fraud risk upon user verification. In some embodiments, once a user (e.g., HELOC applicant) is digitally verified, the present system may authorize the applicant to access the credit line offered by a card company. In some embodiments, to better control the risk associated with the digital verification, instead of offering access to the full line of credit, the present system may allow the applicant to access the partial fund. That is, the applicant is offered an initial amount, which may be smaller than the entire line of credit. For example, if the entire line of credit approved for the applicant is 100K US dollars, the present system may make the initial amount of 10K US dollars (or another value less than 100K US dollars) available to the applicant. The present system may provide the applicant with full fund access when a criterion is met, for example, when the applicant receives the actual physical card and further verification through the physical card is successfully conducted. In another example, if the user is waiting for an RSA token to access the data in one or more data stores, the present system may grant partial access to a subset of the data stores until the user receives the hardware token.

In some embodiments, to achieve the above-described various functions, the present disclosure provides a digital verification system for digital verification purposes, as further described in detail in FIGS. 2-3.

FIG. 2 illustrates an example system 200 for digital verification, according to some embodiments of the disclosure. As illustrated, the digital verification system 200 includes one or more user devices 206a, . . . , 206n (together or individually referred to as “user device 206”) coupled to different users 204a, . . . , 204n (together or individually referred to as “user 204”). Also included in the system 200 is a digital verification server 201 that communicates with user device 206 for implementing the functionalities described herein in the disclosure. In addition, one or more network devices 220 may be also included in the system 200 for setting up communications between different components included in the system. For example, a user device 206 may communicate with the digital verification server 201 through network 220 during digital verification processes.

In some embodiments, each user device 206 and digital verification server 210 may further include an instance of digital verification application 210a/210n/210o (together or individually referred to as “digital verification application 210”), which may implement certain actions necessary for the digital verification. For example, digital verification application 210o on the digital verification server 201 may include one or more classifiers to classify whether a user 204 (e.g., an applicant) has a high risk or low risk based on the information collected for the user 204. In some embodiments, the digital verification application 210o may also include a location information collection unit for collecting the location information of user 204. For example, the location information collection unit of the server 201 may communicate with a user device associated with user 204, and instruct the user device to report the real-time location information of the user 204, thereby enabling the verification of user 204 based on the location information. In some embodiments, the digital verification server 201 may optionally include one or more imaging processing units for detecting the content (e.g., possible address labels) from images or videos submitted by the user 204. In addition, the digital verification server 201 may also extract metadata information from these images or videos to identify location information where these images or videos were taken. The specific functions of the digital verification application 210o are described below in detail in FIG. 3.

A user device 206 may also include an instance of digital verification application 210a/210n, which may be configured to allow the user device 206 to provide the location information to the digital verification server 210, and to submit other digital evidences for verification purposes. For example, a digital verification application 210a/210n may control a digital camera/webcam to turn on to take some images or videos, which can be then submitted (e.g., uploaded through the digital verification application 210a/210n, through email, or through other communication channels).

In some embodiments, a user device 206a/206n may also include one or more sensors 214a/214n (together or individually referred to as “sensor 214”). For example, a user device 206 may include a GPS sensor 214 or another different positioning sensor that can detect the location information of a user 204 in real-time. In some embodiments, sensor 214 can be other types of transceivers to exchange signals with one or more base stations 208 (e.g., satellite base station) to obtain a user's location information. In some embodiments, a user device 206 may be configured to consistently send the location information to the digital verification server 210, to allow the digital verification server 210 to determine whether the user has entered into a residence unit associated with the user from outside the residence unit.

In some embodiments, the disclosed digital verification system 200 may include additional components not described above. For example, one or more data stores may be included in the disclosed system. These data stores may be included in the user devices 206, digital verification server 210 (e.g., a data store 216). These data stores may be used to store data collected and generated during the digital verification processes.

Referring now to FIG. 3, some example components included in a digital verification application (e.g., digital verification application 210o) are further described. According to some embodiments of the disclosure, the digital verification application 210 may include a location unit 302, a contact list classifier 304, and a fraud risk classifier 306. In some embodiments, the digital verification application 210 may optionally include a holistic factor classifier 308 and an access control unit 310.

The location information unit 302 may be configured to verify the location information of a user through different means. This may include verification of the location information of the user in real-time by pinging a user device associated with the user. Images or videos submitted by the user may also be utilized by the location information unit 302 to determine whether the user has access to a resident unit, all of which can be used to digitally verify the user in fraud defense. In some embodiments, not all of this information is required for verification purposes. For example, if the real-time location information clearly shows that the user is inside a residence unit, such information is sufficient to digitally verify the user. The real- time location information can be GPS location information that accurately determines whether the user is inside or outside the residence unit, and the address information shows that the location is only affiliated with one residence unit rather than multiple units, e.g., multiple-floor buildings. In another example, if a video explicitly shows that a user has entered from outside a residence unit into the residence unit, and the video also shows an address label, such video may be also sufficient for location information unit 302 to digitally verify the user. In some embodiments, to lower the risk and improve fraud defense, more than one of the above-described location verification methods may be used.

In some embodiments, when submitting location information as digital evidence, location information reported at multiple time points may be necessary to provide sufficient evidence. For example, background location information reported for N days, spending x % of time at or near the residence unit may be used as sufficient evidence. Here, the values of N and x may be predefined and/or dynamically adjusted by the location information unit 302.

A user's location may be received by location information unit 302 through the user's manual report and/or through a geo-location determination mechanism associated with a user device. In some embodiments, a user device associated with a user (e.g., user device 206 shown in FIG. 2) may be communicatively coupled to a base station 208 in any suitable manner. The user device 206 and base station 208 may be connected by a physical wire or through a wireless connection. For example, a user device (e.g., home desktop computer) accessed by a user may be directly connected to a communication network (e.g., local area network (LAN), internet). When the user is operating on this user device, data packets that include the internet protocol (IP) address assigned to this device at this location can be sent to the location information unit 302 to verify that the user is at home at this specific time point. In another example, the user device may be a portal device (e.g., a smartphone). When a user is present at a location within a wireless range of the base station, this portable device (210a, 210n) may be discovered by the base station through the sensor or transceiver (e.g., 214a, 214n), and the location of the portable device and the user may also be determined (e.g., through trilateration technique or triangulation measures) and sent to the location information unit 302. That is, data packets collected by the portable device can be used by the digital verification application instance (e.g., 210a, 210n) to trigger actions such as pushing messages and prompts to notify the location information unit 302 of digital verification application 210o for verification.

The location information unit 302 may also extract the user location information from the video and/or image submitted by a user. For example, depending on the type and/or configuration of the user device used to take an image, the location information unit 302 may identify the location information by simply checking the image properties, using a software tool to analyze the image, performing reverse image search, etc. The real-time location information obtained from the location information unit 302 is one of the key indicators that digital verification outperforms in delay reduction.

The contact list classifier 304 may be configured to classify a contact list submitted to digital verification server 201 through a user device (e.g., 206a, 206n) associated with a user. For example, a blacklist and/or a whitelist may be previously established and dynamically updated. The contact list classifier 304 may use this blacklist and/or whitelist to check whether any contact point in the contact list submitted by the user is a bad contact point (e.g., suspicious phone number, phony address, invalid name, etc.). If there are one or more bad contact points, the contact list classifier 304 may classify the user as having a high risk. The user is then considered as not digitally verified, and the contact list classifier 304 may not provide full access initially. For example, for a high-risk fund applicant, the contact list classifier 304 may reduce the amount of fund immediately available to the applicant and/or postpone the grant of fund access to the applicant.

In some embodiments, the contact list classifier 304 may use a predetermined threshold value in a classification process. For example, if the number of bad contact points is above the threshold value, the contact list classifier 304 may classify the user as having a high risk. For another example, if the ratio of bad contact points (among all the contact points) in the contact list exceeds the threshold value, the user may be classified as having a high risk. In some embodiments, the contact list classifier 304 may also include the total number of contacts in the contact list as a factor for verification, since a user having fraud activities may try to hide these activities from others and thus have a limited number of contacts or no contact at all in his/her contact list. In some embodiments, the contact list provided by a user may be further verified through different sources. For example, the contact list classifier 304 may verify the contact list by determining whether there is a match between the name and the phone number of each contact.

The fraud risk classifier 306 may be configured to classify a user as having a high or low risk based on a variety of risk factors. The risk factors may include, but are not limited to, a fraud score (e.g., SentiLink score), a phone number confidence level, and a credit score (e.g., FICO score). In some embodiments, the fraud risk classifier 306 may include multiple classifiers. For example, the fraud risk classifier 306 may include a SentiLink classifier, which classifies a user based on his/her SentiLink score. SentiLink® provides an overall synthetic fraud score for decisions, and more nuanced first-party or third-party synthetic scores to drive specific treatment strategies. In some embodiments, the fraud risk classifier 306 may also include a credit score classifier, and/or a phone number confidence classifier. In some embodiments, these different classifiers may work independently in a user risk classification process. In some embodiments, an overall score may be generated based on the outputs from each low fraud risk classifier, which is not limited in the present disclosure.

In some embodiments, the digital verification application 210 may optionally include a holistic factor classifier 308, which may combine the information obtained from all of the above-described classifiers 304 and 306 as well as the location information unit 302. In some embodiments, by generating a more holistic risk view of a user using a holistic factor classifier 308, each aspect of the user can be examined before reaching a conclusion during a digital verification process. This may improve the performance of the disclosed digital verification application 210 in fraud defense.

In some embodiments, the digital verification application 210 may optionally include an access control unit 310 for controlling the early access to the fund (e.g., the line of credit) before a physical card is received by an applicant. The access control unit 310 may determine whether to allow early access to the line of credit based on the digital verification as described above. If a user gets verified through one or more of the above-described verification processes, the access control unit 310 may authorize the user to access the line of credit before the receipt of the physical card, which can be a few days earlier (e.g., 5-7 days earlier) than the current practice (which is about 10 days).

In some embodiments, to control the potential risk, the access control unit 310 may determine an initial amount of fund available to a user, which can be less than the full line of credit approved for the user. For example, the access control unit 310 may define a predefined ratio (e.g., 5%, 10%, 15%, 205, 25%, 30%, 35%, 40%, 45%, 50%, 55%, 60%, etc.) of the full line of credit as the initial amount of fund available to the user. Alternatively, the access control unit 310 may define a predefined amount as the initial amount of fund available to the user. For example, the initial amount can be 5K, 10K, 15K, or 20K US dollars instead. In some embodiments, once the user receives the physical card, the function of the access control unit 310 may be disabled, so that the user may use the full line of credit as normal.

In some embodiments, the access control unit 310 may communicate with one or more of contact list classifier 304, fraud risk classifier 306 or holistic factor classifier 308 to determine and dynamically adjust the ratio or percentage of the initially available amount. For example, if the fraud risk classifier 306 indicates a user is of low risk with a specific low-risk score (e.g., below a risk threshold), the access control unit 310 may determine a high ratio and make a high amount of fund available to this user. However, if there are multiple bad contact points in the contact list analyzed by the contact list classifier 304, the access control unit 310 may lower the initial amount of fund available to the user. Similarly, the access control unit 310 may optionally adjust the timelines to grant the initial access. If a user has a very low-risk score, the access control unit 310 may grant the user partial access immediately after the completion of the verification. Otherwise, the access control unit 310 may impose a calculated interval before making the partial fund/data available to the user (e.g., by requiring the user to provide additional digital evidence within a certain time range in the near future).

In some embodiments, besides the above-described various digital verification approaches, some alternate proofs of physical access may also be considered by the present disclosure. In one example, a QR code may be sent to an applicant via snail mail early on in the funnel without waiting for the card manufacturing or even during the notarization process or the recission period of the HELOC processing. Opening the link associated with the QR code on the user device associated with the applicant may verify the physical access and enable the same early fund access by the user.

In some embodiments, the present system may provide a feedback mechanism to improve the digital verification process over time. For example, if the outcome from one classifier (e.g., 304, 306, or 308) indicates that a user has a high risk and the early access is subsequentially denied, the present system may provide the user with customized feedback to explain why the early access is denied. In some embodiments, the present system may also present one or more GUIs to instruct the user on how to provide additional digital evidences simultaneously.

In some embodiments, one or more artificial intelligence (AI) and machine learning models may be applied to automate the digital verification process and improve accuracy. By analyzing extensive datasets, the present system may use these technologies to detect patterns and anomalies indicative of fraudulent behavior. The present system can also leverage the AI models to learn from previous verification instances, steadily improving accuracy and efficiency.

In some embodiments, the present system may perform AI-driven behavioral analysis to identify deviations and potential threats by monitoring user patterns and actions and flag unusual activities (e.g., inconsistent evidence submission), thereby providing an additional layer of protection against fraud and other risks. For example, the present system may use AI models to recognize user pattern(s) from the submitted evidences and other factors, which can be used for digital verification purposes. For example, the behavior analysis from the AI models shows that a credit card applicant often stays at home at a specific time range(s). The disappearance of such a pattern from the user behavior analysis may draw concerns in the verification process. For example, upon detecting user behavior significantly deviating from the established pattern, the present system may trigger additional verification steps (e.g., instructing the user to provide more data or increasing the data collection frequency) or terminate the verification session. In some embodiments, the present system may utilize AI techniques to enable continuous, secure verification. For example, the present system may apply the AI models to advance the feedback system, and thus provide more relevant, meaningful explanations customized to the users who have been denied early access.

In some embodiments, the present system may use secure channels to ensure safe data exchanges between user devices 206 and digital verification server 201. For example, the present system may encrypt the digital evidences and/or transmit the digital evidences in an encrypted communication channel. The communication between user device 206 and digital verification server 201 may also be performed in the present system using a secure communication protocol such as transport layer security protocol, secure sockets layer protocol, or other suitable secure communication protocols, to further secure the digital verification process.

FIG. 4 illustrates a flow chart of an example method 400 for digital verification and early access to fund. The method 400 may be implemented using the systems shown in FIGS. 2 and 3. It should be noted that the method 400 is provided for exemplary purposes, and not for limitations.

At step 402, the present system may instruct a user to provide personal data. In some embodiments, the personal data includes location information of the user, and the location information can show the user's presence at a location in real-time. In some embodiments, the location information is determined through communications between a portable device associated with the user and a base station using techniques including trilateration or triangulation.

At step 404, the present system may receive behavior data about the user. In some embodiments, the behavior data includes one or more fraud scores or confidence scores that reflect the behavior patterns of the user.

At step 406, the present system may verify the user based on at least one of the personal data and the behavior data. For example, the personal data includes one or more contact lists submitted by the user, and the present system may examine whether the one or more contact lists include an empty list or determine whether the one or more contact lists include a bad contact point.

At step 408, the present system may determine whether to grant the user full access in response to the user verification. The user may be an applicant who is waiting for the arrival of a physical card to access the requested data or fund. Determining whether to grant the user full access comprises determining whether to make partial data or fund available to the user before the arrival of the physical card.

Referring now to FIG. 5, a flow chart of an example method 500 for digital verification using location information is further provided. The example method 500 may be considered a more specific example application of the method 400 described in FIG. 4. It should be noted that the method 500 is provided for exemplary purposes, and not for limitations. In real applications, many other methods may be also available for physical access (to a residence unit) verification and early access to fund (or other address verification-based accesses such as online data access related to certain account information or certain other online digital assets), as described earlier.

At step 502, the location information of a user is collected. The user described in the example embodiment may just have a HELOC card approved and is in the process of waiting for his/her new HELOC card mailed to his/her residence unit (or even in the notarization or recission period). The location information of the user may be collected by pinging the mobile device of the user. For verification purposes, the user may be instructed to be inside the residence unit, on the foreground of the residence unit, or on the back ground of the residence unit when the location information of the user is collected.

At step 504, a video or image showing an evidence of the user having access to a residence unit is received. For example, a video or one or more images show that the user is walking from outside the residence unit associated with the user through the front door of the residence unit. The video or images may be taken by the user as instructed, and may be taken within a specific time period, also as instructed. The video or images may require the user to show his/her face, and/or some proof of identity, such as a driver license in the video or images. In some embodiments, if there are some physical signs that can be used for verification purposes, the user may be also instructed to do so. For example, the present system may require the user to take a video beginning from a street sign, a residence unit sign, or even a close restaurant, pizza store, grocery store, or any other easy-to-verify architecture to begin with.

At step 506, the location information of the user are further verified based on the video or image information. In some embodiments, the location information can be automatically verified by the disclosed system. For example, some image processing techniques may be used by the disclosed system to recognize the objects included in the images or video, which can be further used for verification purposes. In some embodiments, the above-described verification process may generate a risk score, which can be used to determine whether the user has a high, low, or no risk. In one example, if the user has a risk score that is ranked 30% (or another different value) or lower among all users, the user may be considered as having a low risk, and if the user has a risk score that is ranked 5% (or another different value) or lower among all users, the user may be considered as having no risk.

At step 508, if the user is verified as having no or low risk, a partial line access is authorized for the user. In some embodiments, the partial line access may be determined based on the risk score determined for the user. For example, a lower risk score may mean a larger percentage of fund available to the user. In other embodiments, without considering the risk score, a user may be offered a fixed percentage of his/her line of credit, or offered a fixed amount of credit as the initial amount of fund for early access. In some embodiments, the exact value of the initial amount can be dynamically adjusted. For example, if it is found that the user is not actively accessing the initial amount of credit, the initial amount may be increased subsequentially.

At step 510, the user is authorized to access the partial line of credit. In some embodiments, once the user is digitally verified, the user is authorized to access the partial line of credit immediately. This may greatly shorten the waiting time for access to the fund by the user.

In some embodiments, the various methods and systems described above can be implemented through a computing device.

FIG. 6 depicts an example computing device 600 for implementing systems and methods described in reference to FIGS. 1-5. Examples of a computing device may include a mobile device, personal computer, desktop computer, laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like.

In some embodiments, the computing device 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, an input interface 614, and a network adapter 616 are coupled to the I/O controller hub 622. Other embodiments of the computing device 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The input interface 614 is a touch-screen interface, a mouse, trackball, or other types of input interface, a keyboard 610, or some combination thereof, and is used to input data into the computing device 600. In some embodiments, the computing device 600 may be configured to receive input (e.g., commands) from the input interface 614 via gestures from the user. The graphics adapter 612 displays images and other information on the display 618. The network adapter 616 couples the computing device 600 to one or more computer networks.

The computing device 600 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 608, loaded into the memory 606, and executed by the processor 602.

The types of computing devices 600 may vary from the embodiments described herein. For example, the computing device 600 may lack some of the components described above, such as graphics adapters 612, input interface 614, and displays 618. In some embodiments, a computing device 600 may include a processor 602 for executing instructions stored on a memory 606.

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

The phraseology and terminology used herein are for the purpose of description and should not be regarded as limiting.

The term “user” refers to a previous consumer or a non-consumer of one or more financial institutions that offer mortgages and credit lines. In some embodiments, the “user” may be a user (e.g., an account holder or a person who has an account (e.g., banking account, credit account, or the like) at the entity) or potential user (e.g., a person who has submitted an application for an account, a person who is the target of marketing materials that are distributed by the entity, a person who applies for a loan that not yet been funded). It should be noted that the terms user, user, and/or consumer may be used interchangeably throughout the specification.

The indefinite articles “a” and “an,” as used in the specification, unless clearly indicated to the contrary, should be understood to mean “at least one.” The phrase “and/or,” as used in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of” shall have its ordinary meaning as used in the field of patent law.

As used in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

The foregoing description of embodiments has been presented for purposes of illustration and description. It is not intended to be exhaustive or to limit the subject matter to the precise form disclosed, and modifications and variations are possible in light of the above teachings or may be acquired from the practice of the subject matter disclosed herein. The embodiments were chosen and described in order to explain the principles of the disclosed subject matter and its practical application to enable one skilled in the art to utilize the disclosed subject matter in various embodiments and with various modifications as are suited to the particular use contemplated. Other substitutions, modifications, changes, and omissions may be made in the design, operating conditions, and arrangement of the embodiments without departing from the scope of the presently disclosed subject matter.

What is claimed is:

1. A method for real-time, secure digital verification comprising:
instructing a user to provide personal data, the personal data including location information of the user;
receiving behavior data about the user;
verifying the user based on at least one of the personal data and the behavior data; and
determining whether to grant the user access to an asset in response to the user verification.

2. The method of claim 1, wherein the user is an applicant who is waiting for arrival of a physical card to access a requested asset, and determining whether to grant the user access to the asset comprises determining whether to make a partial asset available to the user before the arrival of the physical card.

3. The method of claim 1, further comprising:
receiving a video or image including the location information of the user;
verifying the location information of the user based on video or image information;
determining partial access to the asset for the user based on verifying the user as at least a low-risk user; and
authorizing the user partial access to the asset.

4. The method of claim 3, further comprising analyzing the video or image to extract the location information of the user, wherein the analyzing comprises reverse image search.

5. The method of claim 1, wherein the location information is determined through communications between a portable device associated with the user and a base station using techniques including trilateration or triangulation.

6. The method of claim 1, wherein the location information is collected in real-time.

7. The method of claim 1, wherein the personal data comprises one or more contact lists submitted by the user, and the method further comprises at least one of:
examining whether the one or more contact lists include an empty list; or determining whether the one or more contact lists include a bad contact point.

8. The method of claim 7, further comprising:
comparing a number of bad contact points in the one or more contact lists with a threshold value; and
calculating a ratio of the bad contact points for determining an extent of partial access to the asset.

9. The method of claim 1, wherein the behavior data comprises one or more fraud scores or confidence scores that reflect behavior patterns of the user.

10. The method of claim 1, further comprising applying one or more artificial intelligence (AI) and machine learning models to perform AI-driven behavioral analysis to identify deviations associated with the user in user verification.

11. The method of claim 1, further comprising providing a feedback mechanism in verifying the user, wherein the feedback mechanism is applied using one or more AI models.

12. A system for real-time, secure digital verification, comprising:
a processor; and
a memory in communication with the processor and comprising instructions which, when executed by the processor, program the processor to:
instruct a user to provide personal data, the personal data including location information of the user;
receive behavior data about the user;
verify the user based on at least one of the personal data and the behavior data; and
determine whether to grant the user access to an asset in response to the user verification.

13. The system of claim 12, wherein the user is an applicant who is waiting for arrival of a physical card to access a requested asset, and determining whether to grant the user access to the asset comprises determining whether to make a partial asset available to the user before the arrival of the physical card.

14. The system of claim 12, wherein the instructions further program the processor to:
receive a video or image including the location information of the user;
verify the location information of the user based on video or image information;
determine partial access to the asset for the user based on verifying the user as at least a low-risk user; and
authorize the user partial access to the asset.

15. The system of claim 12, wherein the location information is determined through communications between a portable device associated with the user and a base station using techniques including trilateration or triangulation.

16. The system of claim 12, wherein the location information is collected in real-time.

17. The system of claim 12, wherein the personal data comprises one or more contact lists submitted by the user, and the instructions further program the processor to at least:
examine whether the one or more contact lists include an empty list; or
determine whether the one or more contact lists include a bad contact point.

18. The system of claim 17, wherein the instructions further program the processor to:
compare a number of bad contact points in the one or more contact lists with a threshold value; and
calculate a ratio used to determine an extent of partial access to the asset.

19. The system of claim 12, wherein the instructions further program the processor to apply one or more artificial intelligence (AI) and machine learning models to perform AI-driven behavioral analysis to identify deviations associated with the user in user verification.

20. A computer program product, comprising a non-transitory computer-readable medium having computer readable program code stored thereon, the computer readable program code configured to:
instruct a user to provide personal data, the personal data including location information of the user;
receive behavior data about the user;
verify the user based on at least one of the personal data and the behavior data; and
determine whether to grant the user access to an asset in response to the user verification.
